(19) United States
(12) Patent Application Publication
(10) Pub. No.: US 2017/0074013 A1
(43) Pub. Date: Mar. 16, 2017

(54) DOOR CHAIN DEVICE

(71) Applicant: Patrick J. Doherty, Littleborough (GB)

(72) Inventor: Patrick J. Doherty, Littleborough (GB)

(21) Appl. No.: 15/262,209

(22) Filed: Sep. 12, 2016

(30) Foreign Application Priority Data
Sep. 10, 2015 (GB) 1516028.6

(51) Int. Cl. E05C 17/36

(52) U.S. Cl. CPC E05C 17/365

(57) ABSTRACT

A door chain assembly comprising a chain and an anchor plate. The anchor plate comprises a back plate and a chain-receiving plate and the chain-receiving plate extends from the back plate. The chain-receiving plate is provided with an aperture and/or a chain-holding slot. The chain comprises a plurality of links with adjacent links being rotationally offset with respect to one another.

This application claims priority to United Kingdom Patent Application No. 1516028.6 filed on Sep. 10, 2015 which is hereby incorporated herein by reference.

### FIELD OF THE INVENTION

The invention relates to door looking device that restrict the level to which a door can be opened, particularly for use with front doors to buildings.

### BACKGROUND TO THE INVENTION

Door locking devices, which allow secure limited opening of a door for permitted inspection of a caller but prevent unwanted entry, are generally referred to as “door chains”. These devices usually comprise a short length of chain; a first end of which is secured to a door frame the second end of the chain is releasably secured to a guard plate, with the guard plate being fixedly attached to a door associated with the door frame. When the second end of the chain engages the guard plate, the door chain allows the door to be opened a small amount to confirm the identity of the caller, but prevents unwanted entry, after inspecting the caller, the second end of the chain may be disengaged from the door guard plate allowing the door to be opened fully.

There are shortfalls associated with the most commonly used, conventional door chains of this type. For example, the door chains:
1) do not provide for varying degrees of limited opening of a door;
2) they do not provide adequate protection for the edge of the door against damage caused by contact with the chain; and
3) the chain may to inadvertently disengage the door guard plate when the door vibrates as it is kicked violently by a would-be intruder, thereby compromising security.

### SUMMARY OF THE INVENTION

Accordingly, the present invention is directed to a door chain assembly comprising a chain and a guard plate, wherein:

the guard plate comprises a back plate and a chain-receiving plate, wherein the chain-receiving plate extends from the back plate and the chain-receiving plate is provided with an aperture and/or a chain-holding slot;

and wherein the chain comprises a plurality of links with adjacent links being rotationally offset with respect to one another.

The present invention positions the chain-receiving aperture and/or slot in a position that is non-parallel with the door. As a result, when the chain engages the aperture and/or slot of the guard plate, gravity assists with seating the chain within the aperture and/or slot. Thus, it becomes more difficult for the chain to inadvertently disengage because to do so, the chain has to move away from the floor, rather than simply away from a vertical slot.

Preferably, the chain receiving plate extends away from the back plate at an angle between 45° and 135° from the back plate and, more preferably, the chain-receiving plate extends substantially perpendicularly from the back plate. Again, by positioning the slot to be non-parallel with the door, and preferably substantially parallel with the ground, the likelihood of the chain inadvertently disengaging is reduced.

Advantageously, the aperture and/or the chain-holding slot is provided with removable blocking means and, more advantageously, the removable blocking means is connected to the guard plate and is able to be temporarily displaced from the aperture and/or the chain-holding slot. By providing blocking means that can be inserted and removed from the chain-holding aperture and/or slot, the chain can be prevented from being unintentionally removed from the chain-holding slot.

In a preferable arrangement, the blocking means is biased so that in a rest position it extends at least partially into the aperture and/or the chain-holding slot and it can be at least partially temporarily displaced against the bias to reduce the amount it extends into the aperture and/or the chain-holding slot. Providing bias means, the blocking member has to be actively retracted to engage or disengage the chain. As a result, the chain cannot be inadvertently disengaged, thereby resulting in a more secure arrangement, particularly as the chain is also arranged to be held in the aperture and/or slot by gravity.

In one arrangement, the aperture is in communication with a second slot extending in a different direction from the chain-holding slot and the blocking means engages the second slot and biasing means comprises a compression spring positioned in or adjacent to the second slot to resist movement of the blocking means from the aperture and/or the chain-holding slot. A second slot may be provided to hold the biasing means for the blocking member. This allows for the use of a compression spring, or similar, to be employed to bias the blocking member in a position wherein it blocks the aperture and/or slot.

Advantageously, the blocking member comprises a pivotable cap that is adapted to be received within the aperture. The cap may be connected to the guard plate or the back plate and is able to pivot into, and out of, the aperture and/or slot, thereby blocking the chain from engaging or disengaging the guard plate.

Alternatively, the blocking member comprises a spring member attached to the guard plate, which, in a rest position, extends into the aperture and/or the chain-holding slot and is adapted to be temporarily displaced such that, when in the displaced position, it is clear of the aperture and/or the chain-holding slot. The use of a spring member provided a biasing to the device, which then allows the aperture and/or slot to be blocked and unblocked as required.

It may be desirable that the chain-holding slot comprises at least one angled section. By providing an angle in the chain-holding slot, for example the slot being “V” or “W” shaped, the channel in which the chain is held becomes more complex and makes inadvertent disengaging more difficult. Whilst the slot might be provided with curves, an angle is more difficult for the chain to traverse.

It is advantageous that the longitudinal axis of the links of the chain are substantially perpendicular to one another. Having the links of the chain arranged to be substantially perpendicular to one another allows for the length of the chain to be adjusted by feeding a link into the chain-holding slot in a particular orientation, wherein the adjacent links cannot pass through the chain-holding slot due to their orientation.

The assembly may be provided with a chain anchor plate, which is fixedly attached to a door frame for securing one end of the chain to the door frame. Alternatively, the chain may be connected directly to the door frame.

Preferably, the arrangement between the guard plate and the back plate forms what may be described as a ‘T’ bar as, when viewed from its end, it is generally in the form of a ‘T’ shaped elongate bracket in which the guard chain is engaged in the substantially horizontal limb of the door guard plate.

The central rib of the ‘T’ bar or ‘T’ shaped bracket may define an aperture close to one end and centrally therein, from which a pair of opposing long narrow slots respectively, extend outwardly from the aperture centrally and transversely of the central rib to slot ends adjacent each end of the central rib. Alternatively, a keyhole shaped aperture may be provided in the central rib of the ‘T’ bar with the keyhole aperture adjacent one end of the central rib and a long narrow slot leading from the aperture, centrally of the central rib to a slot end adjacent the other end of the central rib of the ‘T’ bar door guard plate.

The slot in the device may be a closed slot, that is, a slot that has a close periphery.

The back plate may be integral with the guard plate or they may be separate parts that are fixedly connected to one another.

### BRIEF DESCRIPTION OF THE DRAWINGS

The invention will now be described further by way of example, with reference to the accompanying drawings, in which:

FIG. 1 is a front view of a door chain assembly in accordance with the present invention;

FIG. 2 is a perspective view of the assembly of FIG. 1 in a first position;

FIG. 3 is a top view of the assembly of FIG. 1 in a second position;

FIG. 4 is a top view of the door guard plate of FIG. 1;

FIG. 5 is another top view of the assembly FIG. 1;

FIG. 6 is a perspective view of part of the assembly of FIG. 1;

FIG. 7 shows parts of the assembly of FIG. 1;

FIG. 8 is a top view of a second assembly in accordance with the present invention;

FIG. 9 shows a chain for use with the assemblies of the present invention;

FIG. 10 is a front view of the part of the chain of FIG. 9;

FIG. 11 is a perspective view of part of a third assembly in accordance with the present invention;

FIG. 12 is a top view of the third assembly in a first position;

FIG. 13 is a top view of the assembly of FIG. 12 in a second position;

FIG. 14 shows a fourth assembly in accordance with the present invention;

FIG. 15 illustrates a further view of the assembly of FIG. 14;

FIG. 16 is a top view of a fifth assembly in accordance with the present invention;

FIG. 17 is a top view of a sixth assembly in accordance with the present invention;

FIG. 18 is a top view of a seventh assembly in accordance with the present invention;

FIG. 19 shows an eighth assembly in accordance with the present invention;

FIG. 20 shows a ninth assembly in accordance with the present invention;

FIG. 21 shows a tenth assembly in accordance with the present invention;

FIG. 22 shows an eleventh assembly in accordance with the present invention;

FIG. 23 shows a first part for use in a twelfth assembly in accordance with the present invention;

FIG. 24 shows a second part for use with the part of FIG. 23;

FIG. 25 shows an alternative second part for use with the part of FIG. 23;

FIG. 26 is a perspective view of a thirteenth assembly in accordance with the present invention;

FIG. 27 is a perspective view of a further part for use in the assembly of FIG. 26;

FIG. 28 is a perspective view of parts shown in FIGS. 27 and 28 in an assembled arrangement;

FIG. 29 is a further view of the assembly of FIG. 26;

FIG. 30 is a perspective view of a fourteenth assembly in accordance with the present invention;

FIG. 31 is a perspective view of a fifteenth assembly in accordance with the present invention in a first position;

FIG. 32 is a perspective view of the assembly of FIG. 31 in a second position;

FIG. 33 is a perspective view of a sixteenth assembly in accordance with the present invention;

FIG. 34 is a perspective view of a seventeenth assembly in accordance with the present invention;

FIG. 35 is a top view of a eighteenth assembly in accordance with the present invention; and

FIG. 36 is a perspective view of part of the assembly shown in FIG. 35.

### DETAILED DESCRIPTION

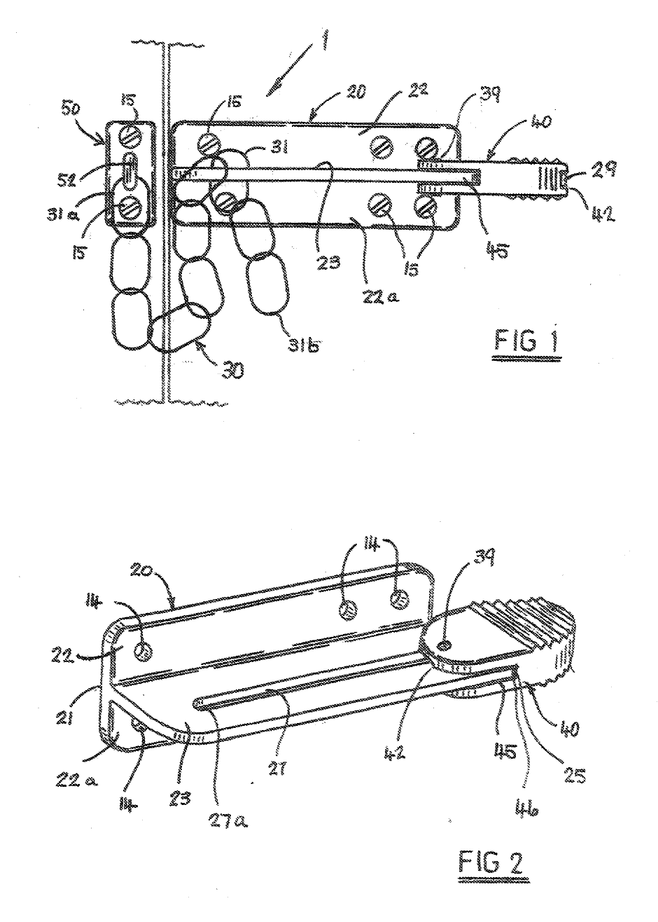

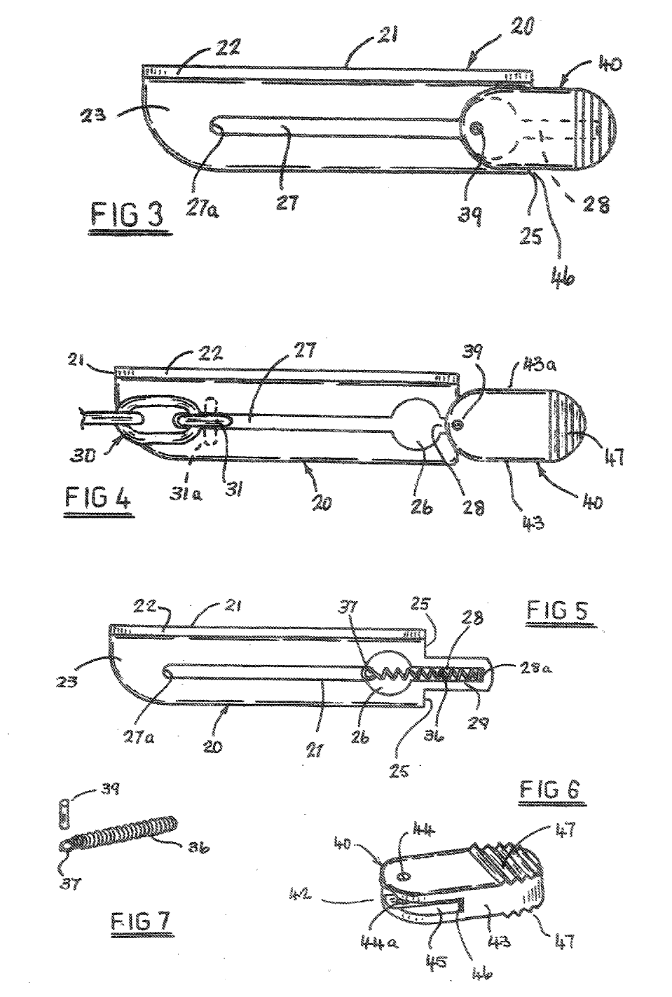

FIGS. 1 to 7 show a first example of a door chain according to the present invention, in which a door chain assembly 1 is provided. The illustration of FIG. 1 shows the assembly fixedly secured to a door and door frame, with the door chain is in its operative or standby condition, wherein one end of the guard chain 30 is secured to the door frame anchor plate 50 by means of its end link 31a. The end link 31a engages the metal loop 52 which forms part of the anchor plate 50, with the anchor plate 50 fixedly secured to the door frame with screws 15. The free end of the guard chain 30 is releasably secured in the narrow slot portion 27 in the door guard plate 20, the guard chain 30 having gained entry to the narrow slot 27 by means of the slot aperture 26, which has a diameter that allows passage of the guard chain 30. The slot aperture 26 is closed, blocked or covered by a handle 40 which is spring biased to the closed position, as shown in FIGS. 2 and 3. It is necessary to move the handle 40 transversely on the guard plate 20 against the force of a small compression spring 36 to provide chain access to the slot aperture 26. The free end of the guard chain 30 may then be lowered through the slot aperture 26 and a chain link 31 selected for engagement in the narrow slot 27, the selected link 31 is then moved to abut the slot end 27a of the narrow slot 27. The slot 27 is a closed slot that has solid periphery.

In the illustration of FIG. 1, the third link 31 from the free end of the guard chain 30 is engaged in the narrow slot 27, engaging the second link on the free end of the chain in the slot 27 will allow the door to be opened the maximum amount allowed by the guard chain. In this manner link selection determines the amount a door may be opened for inspection of a caller, allowing for varying degrees of limited opening of a door. After inspection of a caller the door must be closed to permit removal of the chain 30 from the door guard plate 20 to allow the door to be opened fully.

The door guard plate 20 is in the form of a “T” bar, which comprises a chain-receiving plate in the form of a central rib 23 and a back plate in the form of extended flanges 22. Back plate of the ‘T’ bar provides a pair of extended flanges 22 and 22a that are provided respectively with several spaced screw fixing apertures 14 by means of which the guard plate 20 is fixedly secured to a door. The central rib 23 of the ‘T’ bar extends beyond the end of the extended flanges in the direction distal from the door frame. The extension portion 29 of the central rib 23 is also reduced in width and acts to support a handle 40.

The central rib 23 comprises a slot aperture 26 centrally therein, from which a pair of opposing narrow slots 27 and 28 respectively extend outwardly from the slot aperture 26. The slots 27 and 28 extend centrally and transversely in the central rib to their respective slot ends 27a and 28a, which are adjacent each end of the central rib 23. The long narrow slot 27 which extends towards the front of the guard plate 20, in use, is engaged by the guard chain 30, the short narrow slot 28 accommodates a small compression spring 36 which acts to bias the guard plate handle 40.

The slot aperture 26 facilitates entry of the free end of the guard chain 30 into the door guard plate 20. A link 31 of the guard chain 30 is selected for engagement in the narrow slot 27 and the chain 30 is inserted into the aperture. The selected link 30 is then positioned in, and moved along, the slot 27 towards the front of the door guard plate until the link 31 abuts the slot end 27a. The slot 27 is slightly wider than the diameter of wire from which the chain links are formed, to ensure that a chain link can only pass sideways through the narrow slot 27. Thus, the adjacent link of the chain acts as a stop, thereby providing an interlock between the guard chain 30 and the door guard plate 20. A number of different links on the free end of the guard chain 30 may be engaged within the slot 27 to releasably secure the guard chain 30 to the door guard plate 20. Individual links of the chain 30 directly engaging the door guard plate 20 provide varying degrees of selective and secure limited opening of the door for inspection purposes and the length of the chain 30 restricts the amount by which the door may be opened. The slot aperture 26 and narrow slot 27 being located on the horizontal plane, facilitates easy engagement of the free end of the guard chain 30 and thereby a selected link 31, in the door guard plate 20.

The rear narrow slot 28 in the extended portion 29 of the central rib 23 of the door guard plate 20 is arranged to house a short compression spring 36 the spring 36 comprises a closed loop 37 at one end to receive a retaining pin 39. The spring 36 acts to bias the door guard plate handle 40 to its closed position, in which position it blocks access to the slot aperture 26.

A handle 40 is provided, which may be fabricated from metal or plastic, the external profile of that handle 40 is generally rectangular and is provided with a transverse recess 42 which allows that handle 40 to be mounted on the narrow portion 29 of the central rib 23 and to be a snug, slidable fit thereon. A portion of the sides 43 and 43a of the handle 40 are been removed, indicated by numeral 45 to allow the front end of the handle 40 to project onto the central rib 23 to cover the slot aperture 26 when the handle 40 is in its closed position, as shown in FIGS. 2 and 3. Stop faces 46 on the handle 40 engage the pair of stop faces 25 on the back end of the central rib 23 to limit inward travel of the handle 40. A pair of pin receiving apertures 44 and 44a are defined centrally and adjacent the front of the handle 40 and gripping corrugations 47 or the like may be provided on the top and bottom surfaces of the handle 40.

In order to assemble the handle 40 on the door guard plate 20 the spring 36 is first loaded into the short rear slot 28 of the central rib 29, as shown in FIG. 5, and the handle 40 is then slidably mounted on the narrow portion 29 of the central rib 23 captivating the compression spring 36 on the door guard plate 20. The spring 36 is then compressed against the slot end 28a to align the loop 37 on the end of the spring 36 with the pair of apertures 44 and 44a in the handle 40. The retaining pin 39 is inserted to locate in and bridge the apertures 44 and 44a and be engaged in the loop 37 of the spring 36. The handle 40 is secured on the door guard plate 20 and spring biased transversely thereon to its closed position, in which position it blocks access to the slot aperture 26.

In order to engage the guard chain 30 in the door guard plate 20 the handle 40 is first moved transversely on the central rib 23 against the force of the spring 36 sufficient to expose the slot aperture 26. At this point the spring 36 may have “bottomed”, whilst holding the handle 40 in its open position with one hand the free end of the guard chain 30 is lowered through the slot aperture 26. A link 31 is selected for engagement in the narrow slot 27 and the selected link 31 is moved to abut the slot end 27a, as shown in FIG. 4, after which the handle 40 is then released to automatically close the slot aperture 26. Thus, the guard chain 30 is releasably secured in the door guard plate 20 and cannot be accidentally or inadvertently disengaged from the door guard plate 20. In one construction, when the handle 40 is moved to its open position against the force of the spring 36, it will remain in the open position unaided while the guard chain 30 is being engaged in the door guard plate 20. The handle 40 may then be manually released to close the slot aperture 26.

To disengage the guard chain 30 from the door guard plate 20 the handle 40 is moved transversely on the guard plate 20 against the force of the spring 36 to its open position, exposing the slot aperture 26. With the handle 40 in its open position, the guard chain 30 is moved transversely in the narrow slot 27 and into the slot aperture 26 and the free end of the guard chain 30 can be lifted out of the door guard plate 20.

FIGS. 8 to 10 show a door frame anchor plate 50 described in the previous embodiment and illustrated in FIG. 1 in conjunction with a door guard plate 20a. The door guard plate 20a comprises a short length of metal, generally in the form of a ‘T’ section. The main body 21 of the door guard plate 20a provides a pair of extending flanges 22 and 22a. The flanges 22 and 22a are provided, respectively, with several spaced screw fixing apertures 14 by means of which the door guard plate 20a is fixedly secured to a door. The main central rib 23 of the door guard plate 20a extends past the flanges 22 and 22a on the end of the door guard plate that, in use, is furthest away from the door jamb.

The central rib 23 defines a keyhole slot which comprises a slot aperture 26, dimensioned to permit passage of the guard chain 30, which is provided centrally and adjacent the back end of the central rib 23. A narrow slot 27 extends outwardly from the slot aperture 26 centrally and transversely in the central rib 23 to a slot end 27a adjacent the front end of the door guard plate 20a. In use, the free end of the guard chain 30 is releasably secured in the narrow slot 27.

A chain handle 60 is provided and is secured in the last link 31b on the free end of the guard chain 30. The handle 60, which is in the form of a generally oval metal or plastic disc is stepped 63 to provide a primary body portion 61 and a secondary body portion 62. The primary body portion 61 is dimensioned such that it cannot pass through the narrow slot 27 and can only pass sideways through the slot aperture 26. The width of the secondary body portion 62 of the handle 60 is dimensioned to allow it to pass through the narrow slot 27 thus the handle 60 can only pass sideways through the slot aperture 26 and narrow slot 27 and therefore requires manipulation. An elongated slot 64 is defined centrally in the secondary body portion 62 the aperture 64 extends from the step 63 to adjacent the top of the handle 60. The last link 31b on the free end of the guard chain 30 is fixedly secured in the slot 64 in the guard chain handle 60, the other end of the guard chain 30 is secured to the door frame anchor plate 50 by means of its end link 31a.

The chain handle 60 facilitates engagement and disengagement of the free end of the guard chain 30 in the door guard plate 20a. Requiring that the handle 60 be manipulated in order for the guard chain 30 to be removed from the door guard plate 20a ensures that the guard chain 30 cannot accidentally or inadvertently disengage the door guard plate 20.

In order to engage the guard chain 30 in the door guard plate 20a, the handle 60 is held on its side and partially entered into the narrow slot 27 and slot aperture 26, releasing the handle 60 will cause it to swivel through the narrow slot 27 and aperture 26 on the link 31b which is straddling the narrow slot 27. The link 31b is then moved transversely using the free end of the guard chain 30 to be positioned over the slot aperture 26, at which time the free end of the guard chain 30 may be lowered through the slot aperture 26. A link 31 is then selected and engages in the narrow slot 27 and is moved transversely therein to abut the slot end 27a. The guard chain 30 is now releasably secured in the door guard plate 20a.

To disengage the guard chain 30 from the door guard plate 20a, the free end of the guard chain 30 is moved transversely to disengage the narrow slot 27 and locate in the slot aperture 26. The guard chain 30 may then be drawn upwards through the slot aperture 26 until the handle 60 abuts the side of the aperture 26. When the guard chain 30 is moved transversely so that the link 31b straddles the narrow slot 27, the handle 60 on the link 31b is swiveled and the handle 60 is pushed upwards and through the narrow slot 27 and slot aperture 26.

FIGS. 11 to 15 show door guard plates which employ a plastic or metal closure to shield the slot aperture 26. The closures are required to be moved manually between open and closed positions and are provided to prevent the guard chain 30 inadvertently disengaging the door guard plate.

FIGS. 11 to 13 show a door guard plate 20b, which has a closure 70 that is swivelably mounted on the extension 29a of the central rib 23 by means of the swivel pin 39a. The swivel pin 39a extends through a pair of apertures 75 on the closure 70 and the pin aperture 26a (not shown) in the central rib extension 29a. The closure 70 defines a large open, through slot 74 in one side that is dimensioned to receive the central rib 23. In this manner the closure 70 can cover the slot aperture 26 on both sides of the central rib 23. FIG. 11 is a perspective view of the closure 70.

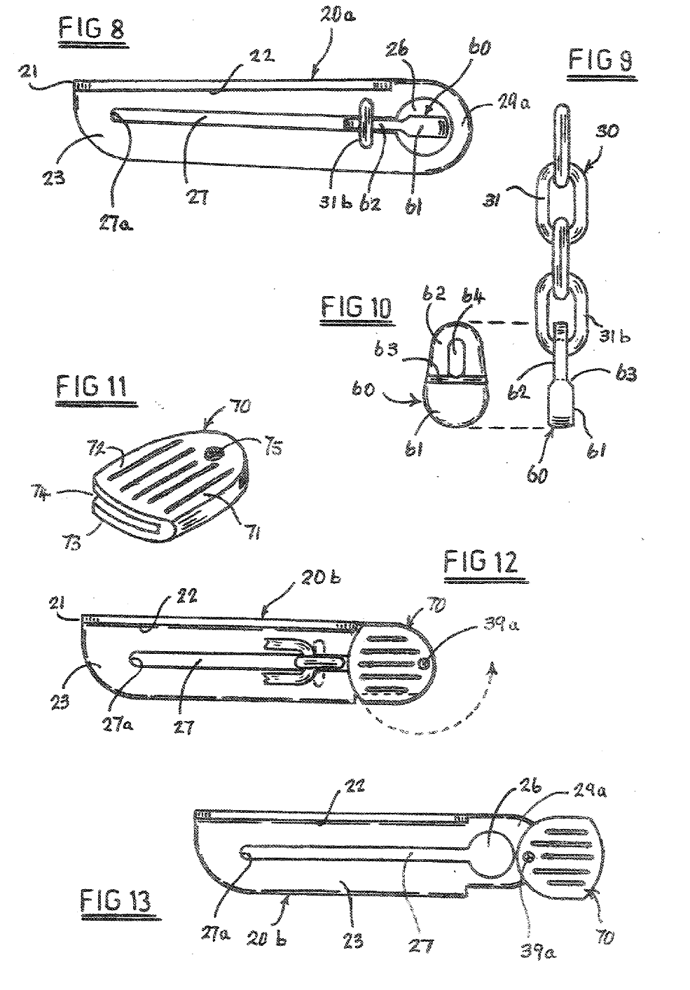

FIG. 12 shows the closure 70 secured to the central rib 23 on the door guard plate 20b, by means of the swivel pin 39a. The closure 70, in its closed position, blocks access to the slot aperture 26 preventing removal of the guard chain 30 from the door guard plate 20b. FIG. 13 shows the closure 70 in its open position, after being swivelled on the pin 39a, allowing access to the slot aperture 26 for removal or insertion of the free end of the guard chain 30. A handle 60 is not required on the free end of a guard chain 30 if the door guard plate has a slot aperture 26 closure. Any available link 31 will act as an interlock between the guard chain 30 and the door guard plate 20b.

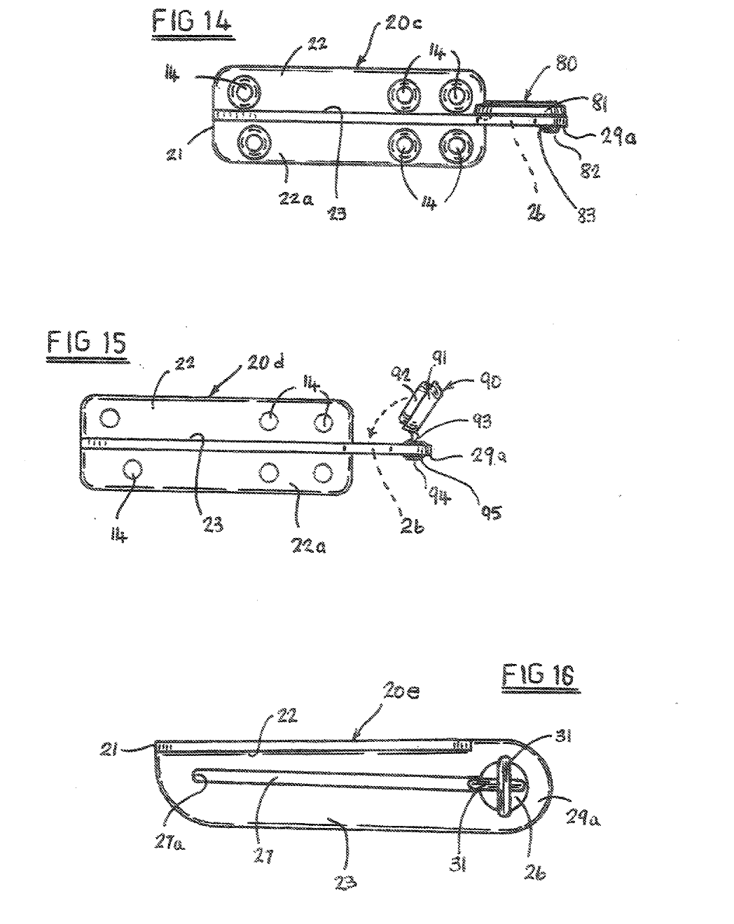

FIG. 14 illustrates a door guard plate 20c that supports a plastic or metal closure 80, which is in the form of a disc having a peg 82 depending outward from its underside. The peg 82 is close to the periphery of the body 81. A small annular bead 83 is provided on the end of the peg 82 which is a push fit into the aperture 26a (not shown) in the central rib extension 29a. In FIG. 14, the closure 80 is shown in its closed position in which position it blocks access to the slot aperture 26, the closure is 80 is swivalable between its two positions on the peg 82. As doors may be hinged on their left or right sides, the closure 80 can be forced out of the central rib extension 29a and inserted on either side thereof to change the orientation of the assembly.

FIG. 15 shows a door guard plate 20d supporting a plastic closure 90 which has an annular stepped body 91 which is attached to a peg 94 by a hinge portion 93, the peg 94 defines a small annular bead adjacent its free end and is a force fit into the aperture 26a (not shown) in the central rib extension 29a. The reduced diameter portion 92 of the main body 91 of the closure 90 is a snug fit in the slot aperture 26 when the closure 90 is in its closed position FIG. 15 shows the closure 90 in its open position, in which the free end of the guard chain 30 is able to access and engage the door guard plate 20d. As with the previous example, the closure 90 can be engaged on either side of the central rib extension 29a.

FIG. 16 shows a door guard plate 20e comprising a slot aperture 26 that will not allow direct passage of the free end of the guard chain 30. In order to releasably secure the guard chain 30 in the door guard plate 20e each of the links 31 on the free end of the guard chain 30 are required to be singularly, manually manipulated. Each link 31 is required to be aligned sideways with the narrow slot 27 when it can be lowered through the slot aperture 26 and narrow slot 27 until the following link 31 abuts the side of the slot aperture 26. The guard chain 30 is then rotated 90 degrees to align the adjacent link 31 with the narrow slot 27, at which time it can be lowered until it abuts the side of the slot aperture 26. In this manner the free end of the guard chain 30 is entered into the door guard plate 20e.

When, for example, a person selects and loads the fourth link 31 from the free end of the guard chain 30 into the door guard plate 20e, that fourth link is then moved transversely in the narrow slot 27 to abut the slot end 27a and the guard chain 30 is then releasably secured in the guard plate 20e. The guard chain 30 is quickly loaded into the door guard plate 20e by alternating rotation i.e. 90 degrees clockwise then 90 degrees anticlockwise; rotating the guard chain 30 clockwise then anticlockwise, alternately, prevents twisting of the guard chain 30.

To disengage the guard chain 30 from the door guard plate 20e, the free end of the guard chain 30 is moved transversely in the narrow slot 27 and into the slot aperture 26 to the position illustrated in FIG. 16. The guard chain 30 is then rotated alternately 90 degrees clockwise then 90 degrees anticlockwise until the guard chain 30 disengages the door guard plate 20e. Requiring that the guard chain 30 be manipulated in this manner ensures that it cannot inadvertently or accidentally disengage the door guard plate 20e.

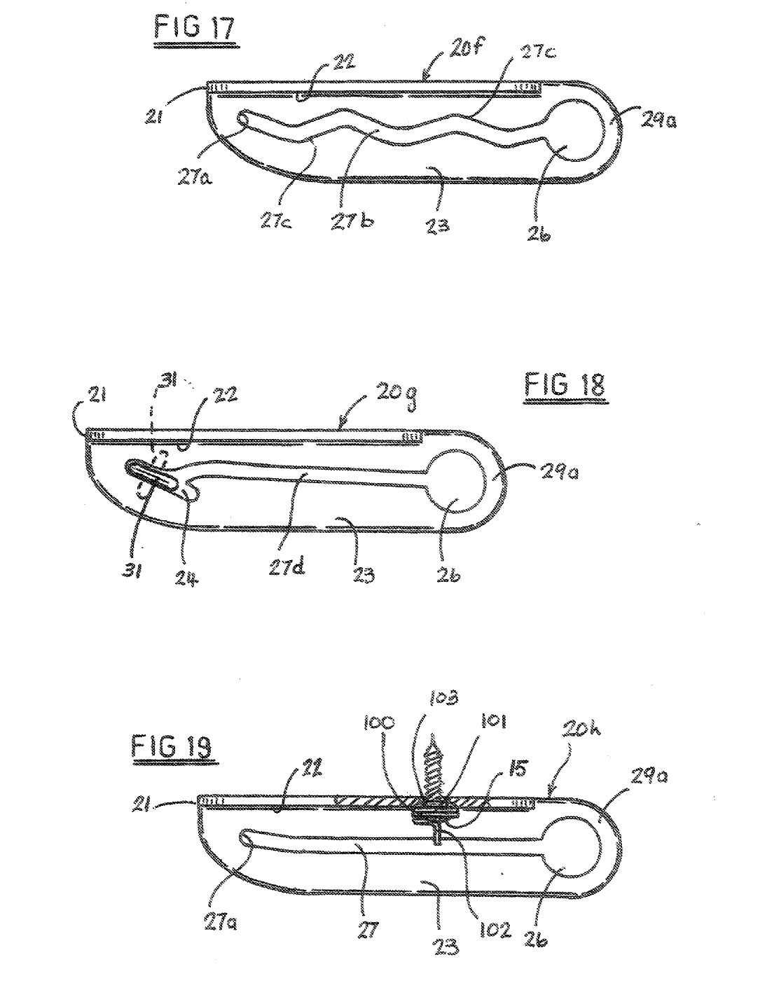

FIGS. 17 and 18 show two door guard plates, 20f and 20g, which are almost identical to the door guard plate 20a of FIG. 8. The difference between the device of FIG. 8 and the one shown herein is that the narrow slot 27 in the door guard plates 20f and 20g has been modified or configured in order to reduce the risk of accidental or inadvertent disengagement of the guard chain 30 from the door guard plates 20f and 20g when the door chain 1 is operational.

FIG. 17 illustrates a door guard plate 20f in which the narrow slot 27b defines corrugations 27c along its length. The corrugations 27c provide a tortuous path for the selected link 31 to traverse. When the door chain 1 is operational and the link 31 abuts the slot end 27a, should the door be violently kicked by a would-be intruder, the corrugations 27c provide resistance to transverse movement of the guard chain 30 in the narrow slot 27b. The door guard plate 20g of FIG. 18 comprises a link enclosure 24 at its slot end which is configured to retain the selected link 31 at the slot end 27a of the door guard plate 20f, in order to prevent the guard chain 30 inadvertently disengaging the narrow slot 27d.

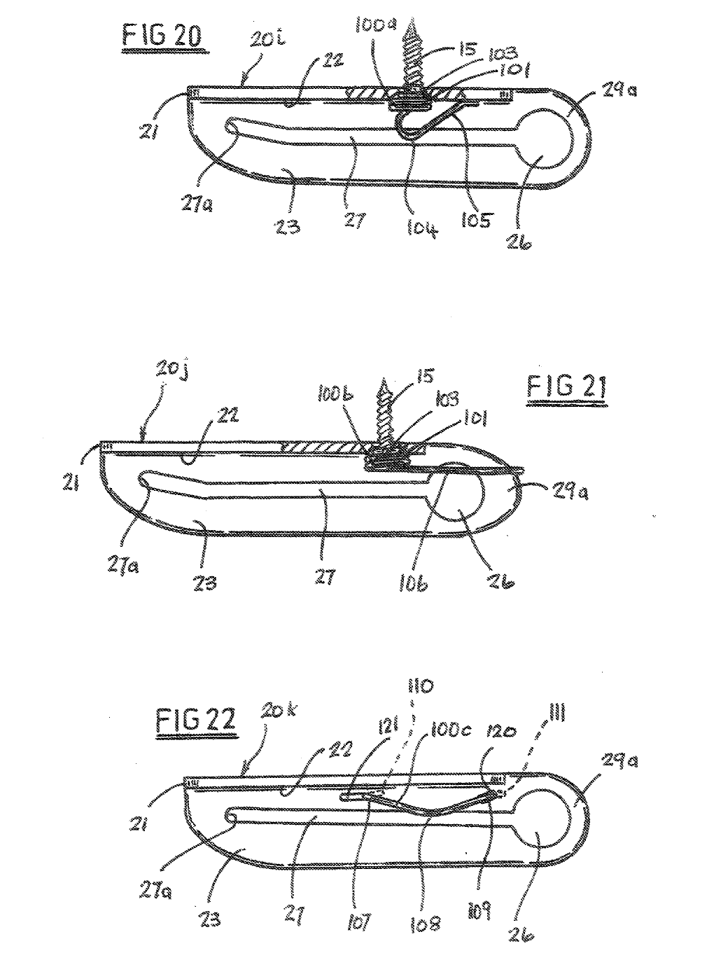

FIGS. 19 to 22, illustrate door guard plates that utilise resilient means to prevent inadvertent disengagement of the guard chain 30 from the door guard plates.

FIG. 19 shows a door guard plate 20h that employs a torsion spring 100 to interfere with the passage of a selected link 31 in the narrow slot 27. The torsion spring 100 is secured to the door guard plate 20h by a fixing screw 15 which locates within the coils 101. The head of the screw 15 grips a reduced diameter coil 103 at the fixed end of the spring 100. The other free end of the spring 100 comprises a leg 102, which is bent at 90 degrees to the spring body 101 and that is spring biased against the central rib 23 of the door guard plate 20h. The leg 102 extends partially into over the narrow slot 27 so as to interfere with the passage of a selected link 31 engaged therein. A selected link 31 is required to be forced past the spring leg 102 as it is being moved to abut the slot end 27a. To releasably secure the guard chain 30 in the door guard plate 20h the free end of the guard chain 30 is lowered through the slot aperture 26 and it engages the selected link 31 in the narrow slot 27. The chain 30 is then pulled sideways on the guard chain 30. The link 31 will abut the spring leg 102, then move the selected link 31 past the spring 100, against the resistance of the spring leg 102 to abut the slot end 27a.

FIG. 20 illustrates a door guard plate 20i, which also utilises a torsion spring 100b. In this embodiment, a loop 104 on the free end of the spring 100a projects partially over the narrow slot 27 to obstruct passage of a selected link 31 therein. The spring loop 104 is spring biased against the surface of the central rib 23. The extended leg potion 105 of the loop 104 is spring biased against the flange 22. The method of engaging the guard chain 30 in the door guard plate 20i is the same as the example of FIG. 19.

FIG. 21 shows a door guard plate, 20j, which incorporates a torsion spring, wherein the leg 106 on the free end of the spring 100b interferes with the passage of the free end of the guard chain 30 in the slot aperture 26 to provide resistance to inadvertent removal of the guard chain 30 from the door guard plate 20j. To releasably secure the free end of the guard chain 30 in the door guard plate 20j, the first link 31 is entered into the slot aperture 26 and pulled down on until the ‘selected’ link 31 is aligned with the narrow slot 27. The guard chain 30 is then moved sideways until the ‘selected’ link 31 abuts the slot end 27a. To disengage the guard chain 30 from the door guard plate 20j the engaged link 31 is moved transversely into the slot aperture 26 and the free end of the guard chain 30 is pulled out of the door guard plate 20j, the spring leg 106 will flex as alternate links 31 are withdrawn.

FIG. 22 illustrates a door guard plate 20k that employs a spring clip 100c to provide resistance to passage of a selected link 31 in the narrow slot 27. The spring wire clip 100c has a main body 108 which is curved. The end 107 of the spring clip 100c is bent at 180 degrees to form a hook 110, which passes through an elongated slot 121 in the central rib 23 to anchor the end 107 of the spring clip 100c to the central rib 23, the other end 109 of the spring clip 100c is bent to form a hook 111 which also passes through an elongated slot 120 in the central rib 23 to anchor the other end 109 of the spring clip 100c to the central rib 23. The main body 108 of the spring clip 100c is spring biased against the surface of the central rib 23 and projects partially over the narrow slot 27 to provide resistance to passage of a selected link 31 therein. All other aspects of this example, including engaging and disengaging the guard chain 30 in the door guard plate 20k, have been covered in relation to FIGS. 19 and 20.

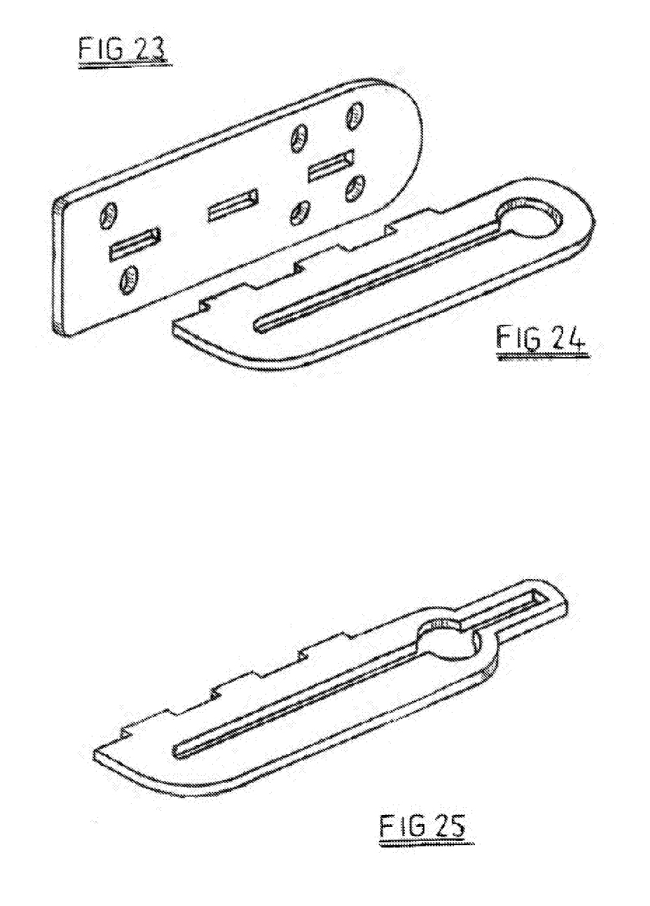

FIGS. 23 to 25 illustrate an example of a back plate and two chain-receiving plates according to the present invention. The plates are fabricated as a pressing from a flat metal strip or blank, although they may be produced by way of laser cutting a large sheet of metal.

FIG. 23 is a perspective view of the back plate, which comprises a number of spaced screw receiving apertures adjacent the sides thereof, along with three spaced elongated slots positioned centrally and transversely therein. The slots are dimensioned to receive three corresponding lugs that extend from the back side of the chain-receiving plates shown in FIGS. 24 and 25. The back plate of FIG. 23 may be used with either of the chain-receiving plates shown in FIGS. 24 and 25.

On assembly of the embodiment shown in FIGS. 23 to 25, a chain-receiving plate (FIG. 24 or 25) is engaged on the back plate of FIG. 23 by engaging the lugs of the chain-receiving plate into the respective apertures of the back plate. Once engaged, the two components are fixedly secured together by welding, which is applied from the back side (the side away from the chain-receiving plate) of the back plate. The welded surfaces may then be easily and quickly dressed on a grinding machine. Thus, when the door guard plate is secured to a door there are no visible signs of welding.

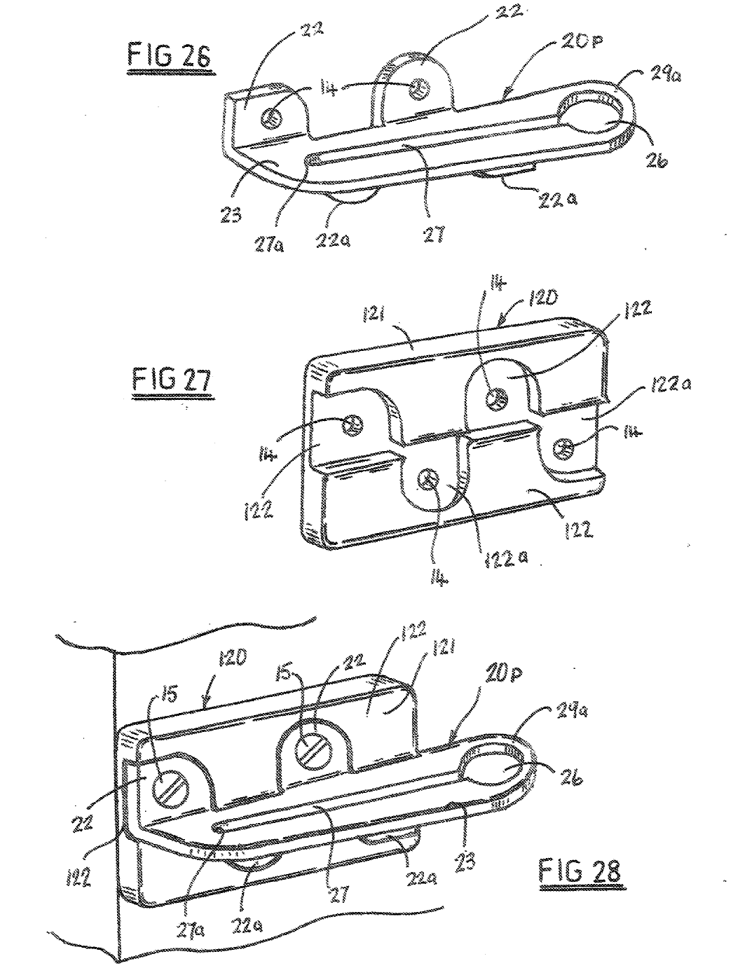

FIGS. 26 to 29 illustrate a further example of a door guard plate 20p which may be formed as a pressing by piercing and folding a flat metal blank or strip. The door guard plate 20p performs the same function as the guard plate 20a of FIG. 8. The door guard plate 20p is generally a short ‘T’ profile bracket having two pairs of lugs 22 and 22a respectively extending at 90 degrees outward of the central rib 23 and on either side thereof. Each of the lugs is provided with a screw receiving aperture 14, by means of which the door guard plate 20p is secured to a door. The lugs 22 and 22a perform the same function as the extended flanges 22 and 23 of the previously discussed embodiments. A back plate 120, which may be plastic or a metal die casting, is provided with the door guard plate 20p. The back plate 120 acts as a door edge protector and to improve aesthetics. Recesses 122 and 122a are provided in the front face 122 of the back plate 120 to receive the lugs 22 and 22a respectively of the door guard plate 20p in order that the lugs 22 and 22a may be flush with the front surface 122 of the back plate 120. Screw receiving apertures 14 in the back plate 120 are aligned with corresponding screw receiving apertures 14 in the lugs 22 and 22a in the door guard plate 20p. The operational aspects of this example of door guard plate are the same as those for the assemblies shown in FIGS. 8 and 16.

FIG. 30 illustrates a door guard plate 20q that is formed as a metal pressing or fabricated from a short length of 90 degree metal angle section. The door guard plate 20q is provided with a metal or plastic back plate 130 which acts as a door edge protector. The door guard plate 20q comprises a main body 23a, which has a slightly shorter flange portion 22 extending therefrom at 90 degrees. The flange 22 is provided with several spaced screw receiving apertures 14, by means of which it is secured to a door. The longer main body 23a of the door guard plate 20q defines a slot aperture 26 adjacent its back end and a narrow slot 27 extends outwards from the slot aperture 26, centrally on the main body 23a to a slot end 27a which is close to the front end of the main body 23a. The back plate 130 is the same length as the flange 22 and just over twice the width. Two sets of screw receiving apertures 14 are provided in the back plate 130 and align with corresponding screw receiving apertures 14 in the flange 22. The operational aspects of the door guard plate 20q are the same as those described in relation to the assemblies of FIG. 8 and FIG. 16.

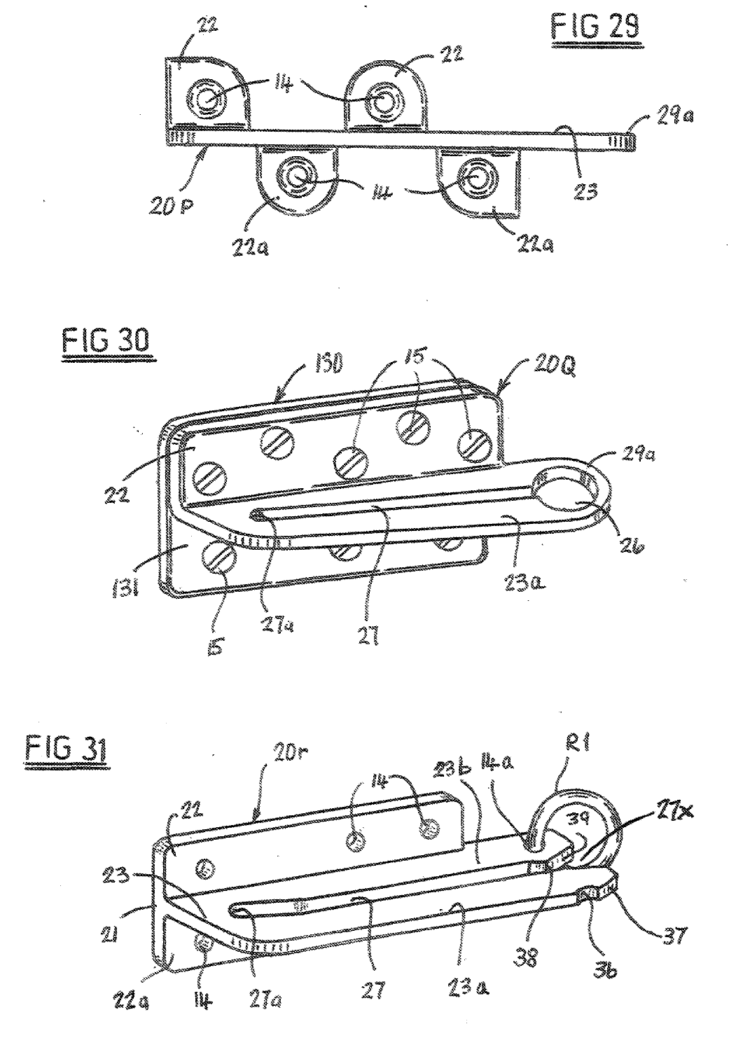

FIGS. 31 to 36 show a door guard plate 20r that is generally in the form of a short length of metal ‘T’ section. Extended flanges 22 and 22a, which extend substantially perpendicularly from each side of the main central rib 23, are provided with spaced screw receiving apertures 14 for fixedly securing the door guard plate 20r to a door. The main central rib 23 extends beyond the flanges 22 and 22a on the end of the door guard plate that, in use, is furthest away from the door jamb. The central rib 23 defines a narrow entry slot 27x located centrally and transversely therein, leading from the back end of the door guard plate 20r to a slot end 27a close to the front of the door guard plate 20r. The slot 27 facilitates entry and engagement of a link 31 or links on the free end of the guard chain 30 in the door guard plate 20r to releasably secure the guard chain 30 to the door guard plate 20r.

The entry 27x to the narrow slot 27 is at the end of the door guard plate 20r that, in use, is furthest away from the door jamb. The slot 27 is on the horizontal plane and facilitates easy engagement of a selected link 31 therein. The links 31 can only pass sideways in the narrow slot 27, thus the link adjacent a selected link 31 provides an interlock between the guard chain 30 and the door guard plate 20r. A number of different links on the free end of the guard chain 30 may be engaged singularly in the narrow slot 27 to releasably secure the guard chain 30 to the door guard plate 20r. Individual links 31 on the free end of the guard chain 30 directly engaging the door guard plate 20r, provide varying degrees of selective and secure limited opening of a door for inspection of a caller. The last link 31b on the free end of the guard chain 30 determines the maximum amount the door may be opened. The last link 31b may be engaged on the flexible limb 23a of the door guard plate 20r, the inner surface of the link 31b abutting the slot end 27a.

An aperture 14a is provided at the back end of the central rib 23 adjacent the entry 27x on the flange side 23b of the narrow slot 27, the aperture 14a is to receive a metal ring R1, the ring R1 is captive in the aperture 14a and swivelably moveable therein between an unlocked position, in which it permits access for the free end of the guard chain 30 to the narrow slot 27, and a locking position, in which, it locks the free end of the guard chain 30 in the door guard plate 20r, when the door guard plate 20r is operational. An annular cut-out or holding recess 36 is provided in the edge of the resilient limb 23a adjacent the free end of the resilient limb 23a. The cut-out is provided to locate the one side of ring R1 when the ring R1 is in its locking position.

An angled lead or ramp 37 extends from the holding recess 36 to the end of the limb 23a the lead 37 acts to guide the ring R1 into the holding recess 36 as the ring R1 is moved up the lead 37 against the force of the resilient limb 23a to snap engage the holding recess 36. The ring R1 in its locking position, acts to support the flexible limb 23a preventing it moving outward of the door guard plate 20r. The ring R1 prevents inadvertent removal of the guard chain 30 from the door guard plate 20r.

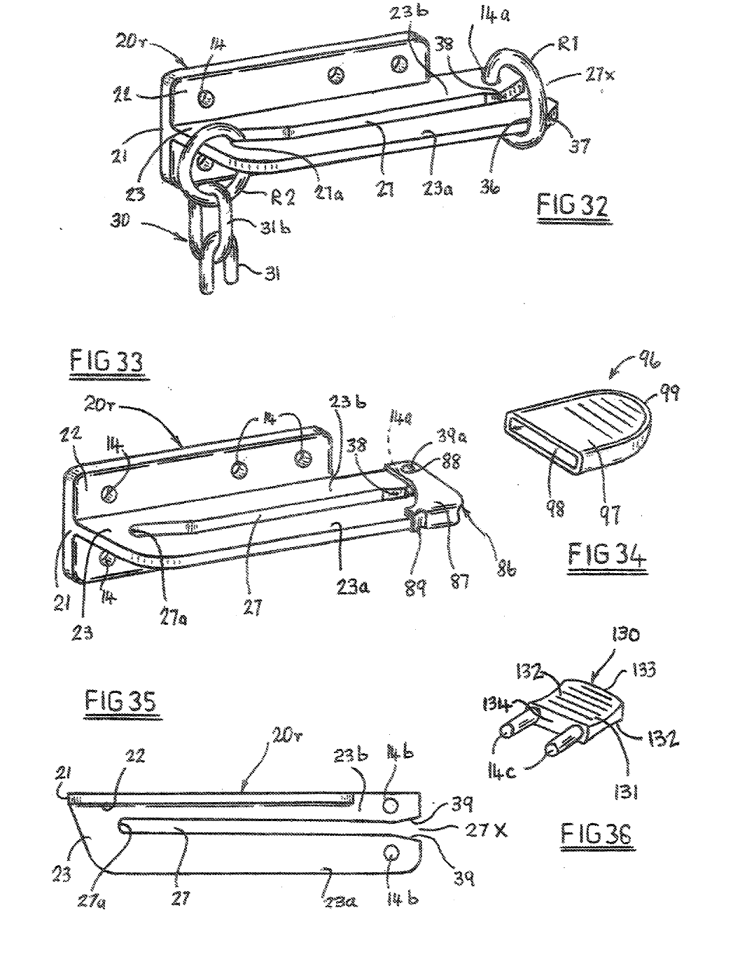

FIG. 32 is a perspective view of the door guard plate 20r which has a ring R2 releasably secured in the narrow slot 27. The last link 31b on the free end of the guard chain 30 is fixedly secured to the ring R2 and the ring R2 is engaged on or over the flexible limb 23a of the door guard plate 20r and the inside surface of the ring R2 is abutting the slot end aperture 27a. The ring R2 may be provided on the free end of the guard chain 30 as a handle for the chain. The rings R1 and R2 are, preferably, the same size. The guard chain links 31 and the end link 31b which is attached to the ring R2 are required to be engaged singularly and sideways in the narrow slot 27 to provide varying degrees of selective, limited opening of a door.

A small hump 38 may be provided adjacent the entry 27x to the narrow slot 27, the hump 38 projecting from the flange side 23b of the central rib 23 into the narrow slot 27, the small hump 38 will provide resilient resistance to removal of a selected link or ring R2 from the narrow slot 27 in the door guard plate 20r. The hump 38 would not be required if a locking ring R1 or slot closure is provided. The slot entry 27x may have curved or tapered entry leads 39 to assist in locating a selected link 31 on the free end of the guard chain 30 in the narrow slot 27.

FIG. 33 is a perspective view of the door guard plate 20r which has a closure 86 swivalably secured on the limb 32b adjacent the narrow slot entry 27x. The closure 86 is secured to the door guard plate 20r by means of a swivel pin 39a, which engages the apertures 88 defined in the body 87 of the closure 86 and the aperture 14a in the limb 23b. An indent 89 in the side of the closure 86 snap-engages the holding recess 36 in the resilient limb 23a of the door guard plate 20r when the closure 86 is swivelled to its closed position, in which position it prevents inadvertent disengagement of the guard chain 30 from the door guard plate 20r. FIG. 33 shows the closure in its locking position. The flexible limb 23a may be depressed inwards to relieve pressure between the flexible limb 23 and the indent 89, when moving the closure 86 from its locked to its unlocked position, when the free end of the guard chain 30 may be released from the door guard plate 20r.

FIG. 34 illustrates an alternative closure 96 for the door guard plate 20r. The closure 96 comprises a short, thin walled rectangular sleeve, of which the back end 99 is closed and is preferably slightly curved. The internal bore 98 of the closure 96 is dimensioned to be a snug fit on the central rib limbs 23a and 23b. The resilient, flexible limb 23a will provide that the closure 96 is firmly gripped when it is pushed onto the door guard plate 20r to lock the free end of the guard chain 30 therein. In use, the closure 96 is stowed on the door guard plate 20r and is only removed to allow the guard chain 30 to be releasably secured in the guard plate 20r.

FIGS. 35 and 36 illustrate the door guard plate 20r which has been modified to enable it to receive a thumb clip 130 as means to prevent the free end of the guard chain 30 inadvertently disengaging the door guard plate 20r. The door guard plate 20r is provided with a pair of spaced apertures 14b adjacent the free ends of the limbs 23a and 23b respectively, the opposing apertures 14b are to receive respective prongs 14c on the double pronged thumb clip 130. The thumb clip 130 is used to bridge the narrow slot 27 to prevent inadvertent disengagement of the free end of the guard chain 30 from the door guard plate 20r when the door chain 1 is operational.

The thumb clip 130 comprises a short narrow body 131, the sides 132 of which are dished to facilitate gripping and the back end 133 of the thumb clip 130 is curved. A pair of spaced prongs 14c extend outwardly from the front end 134 of the thumb clip 130. The prongs 14c engage and locate respectively in the apertures 14b in the door guard plate 20r. The length of the prongs 14c ensures that the thumb clip 130 is adequately engaged in the door guard plate 20r. In use, the thumb clip 130 is stowed on the door guard plate 20r and is only removed to allow the guard chain 30 to be releasably secured in the guard plate 20r.

It is to be understood, that any suitable door frame anchor plate 50 or anchor means may be used in conjunction with the door guard plates illustrated and described in this specification, to fixedly secure one end of the guard chain 30 to a door frame.

The same numerals have been used throughout this specification to denote similar components.

1. A door chain assembly comprising a chain and an anchor plate, wherein:
the anchor plate comprises a back plate and a chain-receiving plate, wherein the chain-receiving plate extends from the back plate and the chain-receiving plate is provided with an aperture and/or a chain-holding slot;
and wherein the chain comprises a plurality of links with adjacent links being rotationally offset with respect to one another.

2. A door chain assembly according to claim 1, wherein the chain receiving plate extends away from the back plate at an angle between 45° and 135° from the back plate.

3. A door chain assembly according to claim 2, wherein the chain-receiving plate extends substantially perpendicularly from the back plate.

4. A door chain assembly according to claim 1, wherein the aperture and/or the chain-holding slot is provided with removable blocking means.

5. A door chain assembly according to claim 4, wherein the removable blocking means is connected to the anchor plate and is able to be temporarily displaced from the aperture and/or the chain-holding slot.

6. A door chain assembly according to claim 5, wherein the blocking means is biased so that in a rest position it extends at least partially into the aperture and/or the chain-holding slot and it can be at least partially temporarily displaced against the bias to reduce the amount it extends into the aperture and/or the chain-holding slot.

7. A door chain assembly according to any claim 6, wherein the aperture is in communication with a second slot extending in a different direction from the chain-holding slot and wherein the blocking means engages the second slot and biasing means comprises a compression spring positioned in or adjacent to the second slot to resist movement of the blocking means from the aperture and/or the chain-holding slot.

8. A door chain assembly according to claim 5, wherein the blocking member comprises a pivotable cap that is adapted to be received within the aperture.

9. A door chain assembly according to claim 5, wherein the blocking member comprises a spring member attached to the anchor plate, which, in a rest position, extends into the aperture and/or the chain-holding slot and is adapted to be temporarily displaced such that, when in the displaced position, it is clear of the aperture and/or the chain-holding slot.

10. A door chain assembly according to claim 1, wherein the chain-holding slot comprises at least one angled section.

11. A door chain assembly according to claim 1, wherein the longitudinal axis of the links of the chain are substantially perpendicular to one another.

12. A door chain assembly according to claim 1, wherein the slot is a closed slot.
